(19) United States
(12) Patent Application Publication
(10) Pub. No.: US 2006/0105822 A1
(43) Pub. Date: May 18, 2006

(54) Open architecture mobile electronic device

(76) Inventors: Tony Hancock, Stone Mountain, GA (US); Isaac S. Giles, Atlanta, GA (US)

Correspondence Address: Malcolm E. Whittaker, Suite 606, 8 Greenway Plaza, Houston, TX, 77046, US

(21) Appl. No.: 11/252,946

(22) Filed: Oct. 18, 2005

Related U.S. Application Data
(60) Provisional application No. 60/619,673, filed on Oct. 18, 2004.

(51) Int. Cl. H04B 1/08; H04B 1/03

(52) U.S. Cl. 455/575.3; 455/566; 455/90.2; 455/351

(57) ABSTRACT

A portable electronic device includes a body having pivotally joined front and back sections such that an interior space is defined therebetween. At least one receptacle is formed in the body for releasable connection of a viewing device therein. At least one receptacle is formed in the body for releasable connection of a storage device therein. The device includes means for communicating electrical signals between the at least one viewing device and the at least one storage device and means for communicating between the at least one viewing devices and at least one peripheral device.

### CROSS-REFERENCE TO RELATED APPLICATIONS

This invention claims priority from U.S. Provisional Application No. 60/619,673 filed on Oct. 18, 2004.

### STATEMENT REGARDING FEDERALLY SPONSORED RESEARCH OR DEVELOPMENT

Not applicable.

### BACKGROUND OF INVENTION

1. Field of the Invention

The invention relates generally to the field of portable electronic devices. More particularly, the invention relates to portable electronic devices having interchangeable sub-systems such that the device can be used for a plurality of different purposes.

2. Background Art

At the present time, a variety of mobile electronic devices exist. For example, portable CD players, portable radios, portable computers and mobile telephones are a few of the portable electronic devices available today.

Generally, these devices are limited to a single function and cannot be readily expanded to perform additional functions. In addition, existing devices also must be carried in the user's hands or attached to a belt loop. As such, mobile devices are limited to a relatively lightweight.

Also, existing devices typically cannot communicate or interact with an external device that may attempt to communicate with the mobile device. For example, a mobile phone cannot automatically print a coupon for a soft drink when the owner passes a convenience store. Accordingly, there is a need in the art for improved mobile electronic devices.

Accordingly, there is a need in the art for improved mobile electronic devices.

### SUMMARY OF INVENTION

One aspect of the invention is a portable electronic device including a body having pivotally joined front and back sections such that an interior space is defined therebetween. At least one receptacle is formed in the body for releasable connection of a viewing device therein. At least one receptacle is formed in the body for releasable connection of a storage device therein. The device includes means for communicating electrical signals between the at least one viewing device and the at least one storage device and means for communicating between the at least one viewing devices and at least one peripheral device.

Other aspects and advantages of the invention will be apparent from the following description and the appended claims.

### BRIEF DESCRIPTION OF DRAWINGS

FIG. 1 is a front plan view of an embodiment of the present invention.

FIG. 1A is a front plan view of an alternative embodiment of the present invention illustrating devices that can be used in conjunction with the present invention.

FIG. 2 is a reverse plan view of the present invention.

FIG. 3 is a side plan view of the present invention in the closed position with the straps retracted.

FIG. 4 is a side plan view of the present invention seen in FIG. 3 with the straps extended to allow a user to carry the present invention.

FIG. 5 is side plan view of the present invention in the open position.

FIG. 6 is a front plan view of an alternative embodiment of the present invention.

FIG. 7 is a front plan view of another alternative embodiment of the present invention.

FIG. 8 is a front plan view another alternative embodiment of the present invention.

FIG. 9 is a front plan view of an alternative embodiment of the present invention with multiple view screens.

FIG. 10 is a front plan view of an alternative embodiment of the present invention with multiple view screens located in alternative positions.

FIG. 11 is a front plan view of an embodiment of the present invention illustrating the ability of the present invention to communicate wirelessly with a variety of external devices, including, but not limited to, keyboards, headphones, joysticks and remote controls.

FIG. 12 is a front plan view of an embodiment of the present invention illustrating the ability of the present invention to communicate wirelessly with an external device, such as wireless node in a store.

FIG. 13 is a front plan view of an embodiment of the present invention illustrating the ability of the present invention to communicate wirelessly with an external device, such as a voting booth.

FIG. 14 is a front plan view of two of the present invention illustrating the ability of the present invention to communicate wirelessly with other Open Architecture Mobile Electronic Devices.

FIG. 15 is a front plan view of a preferred embodiment of the present invention.

FIG. 15A is a front plan view of an alternative preferred embodiment of the present invention illustrating devices that can be used in conjunction with the present invention.

FIG. 16 is a reverse plan view of a preferred embodiment of the present invention.

FIG. 17 is a side plan view of a preferred embodiment of the present invention in the closed position with the straps retracted.

FIG. 18 is a side plan view of the present invention seen in FIG. 17 with the straps extended to allow a user to carry the present invention.

FIG. 19 is side plan view of a preferred embodiment of the present invention in the open position.

FIG. 20 is a front plan view of a preferred embodiment of the present invention illustrating the ability of the present invention to communicate wirelessly with a variety of external devices, including, but not limited to, keyboards, headphones, joysticks and remote controls.

FIG. 21 is a front plan view of a preferred embodiment of the present invention illustrating the ability of the present invention to communicate wirelessly with an external device, such as wireless node in a store.

FIG. 22 is a front plan view of a preferred embodiment of the present invention illustrating the ability of the present invention to communicate wirelessly with an external device, such as a voting booth.

FIG. 23 is a front plan view of two of the preferred embodiments of the present invention illustrating the ability of the present invention to communicate wirelessly with other Open Architecture Mobile Electronic Devices.

### DETAILED DESCRIPTION

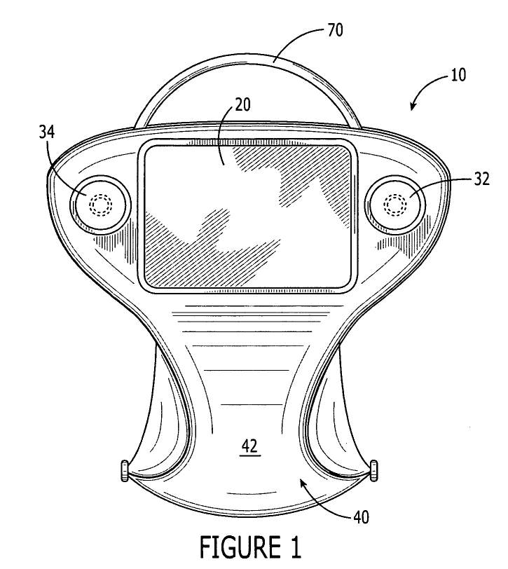

FIG. 1 illustrates a first embodiment of an Open Architecture Mobile Electronic Device, shown generally at 10, according to various aspects of the invention. The Open Architecture Mobile Electronic Device 10 includes a view screen 20, speakers 32 and 34 and body 40. The view screen 20 may be a flat screen liquid crystal video display, a conventional cathode ray tube display, or any type of computer or video display device known in the art. Preferably, the view screen 20 may be readily detachable from the body 40 of Open Architecture Mobile Electronic Device 10. The view screen 20 may be detachable for purposes of replacing it with another, different type of viewing screen, or the view screen 20 may be detached to serve as a cordless view screen to allow the user to watch conventional broadcast television, or to watch playback of DVD's or similar media, as seen in FIG. 1A. The view screen 20 may thus include a wireless communication device (not shown) for communicating signals to corresponding circuitry in the body (explained below with reference to FIG. 1A), or may include conventional television receiver circuitry or a DVD player (not shown separately). Speakers 32 and 34 are used to play the audio portion of any media played by the Open Architecture Mobile Electronic Device 10.

Referring to FIG. 1A, typically, the Open Architecture Mobile Electronic Device 10 will also include a slot 60 to receive various media playback or storage devices (explained further below). Speakers 32 and 34 may be detachable for purposes of replacing them with other speakers or speakers 32, 34 may be detached to serve as wireless speakers to allow the user to obtain better sound quality, or the speakers 32, 34 may be hard-wired to the circuitry in the body 40. In addition, the view screen 20 may be a view screen for a game or to display a signal from a remote source.

The body 40 is preferably made of a material such as a hard, impact resistant plastic, glass fiber reinforced plastic or any similar material that will resist damage from impact that may occur when a user is carrying or transporting the Open Architecture Mobile Electronic Device 10.

As shown in FIG. 1A, slot 60 allows a user to insert therein a selection of media readers, such as DVD player 150 or a CD player 160. In addition, slot 60 could also be used to engage a coupon printer 120 or a line printer 122. It is within the scope of the present invention for the Open Architecture Mobile Electronic Device 10 to include a plurality of such slots. If the Open Architecture Mobile Electronic Device 10 includes more than one such slot 60, the user can use multiple, similar devices simultaneously.

As shown in FIG. 1, the Open Architecture Mobile Electronic Device 10 includes a hand strap 70. The strap 70 allows the user to comfortably lift and transport the Open Architecture Mobile Electronic Device 10. Preferably, the strap 70 is sufficiently strong and fastened to the Open Architecture Mobile Electronic Device 10 so that it will not detach, and will allow the user to accidentally drop Open Architecture Mobile Electronic Device 10 without breakage.

FIG. 1A shows additional components that may be included in some embodiments of the Device 10. A bus controller 11, which may be any integrated microprocessor based controller, such as one sold under product designation 80486 by INTEL Corp., and is used to transfer signals and data between the various components forming part of the Device 10. For example, the controller 11 may be hard-wired to a connector 12A for the view screen 20. The controller 11 may also include suitable digital to analog processing circuitry such that output connections, at 12C, may be provided for the Speakers 32, 34. The speaker connections 12C may be hard wired such as through cables 34A, or the speaker connections 12C may be wireless. Wireless speaker connections known in the art include frequency modulation (FM) transmitter/receiver pairs, among other such wireless connections. The controller 11 may also be operatively connected to a wireless broadband (Internet) transceiver, shown generally at 13. The transceiver 13 may be coupled to an antenna 99 for communication with various remote devices as will be further explained below. The controller 11 may also be coupled to a corresponding connector 12B in the slot 60 to make power and signal connection to the various mass storage/media devices when inserted in the slot 60. Alternatively, each such mass storage/media devices may themselves include wireless telemetry for communication with the controller 11. Accordingly, the exact configuration of electrical power and signal communication between the various devices when disposed in or near the body 40 is not a limitation on the scope of this invention.

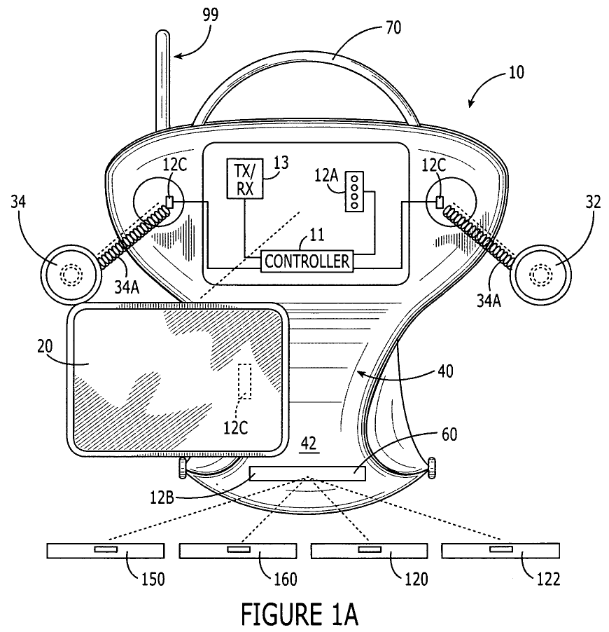

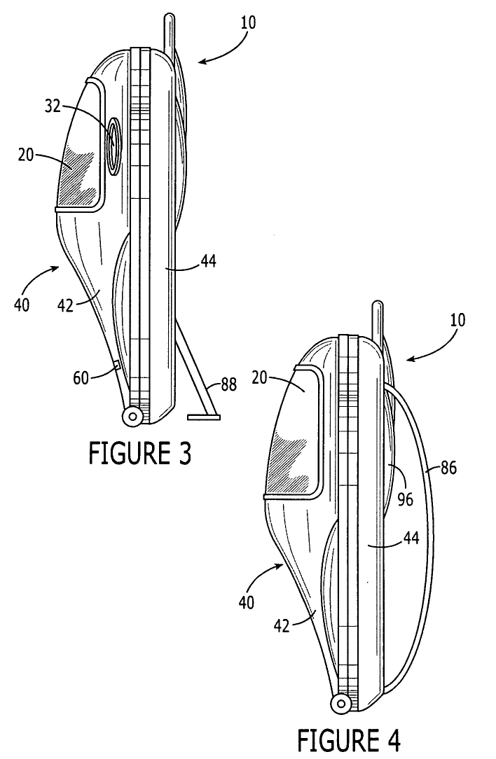

FIGS. 2 and 4 show the reverse side of the Open Architecture Mobile Electronic Device 10. Straps holders 82′ and 84′ connect to strap connection points 82 and 84 respectively using straps 86. The cushions 92 and 94 are positioned on the body 40 to maximize the user's comfort when transporting Open Architecture Mobile Electronic Device 10 using shoulder straps 86.

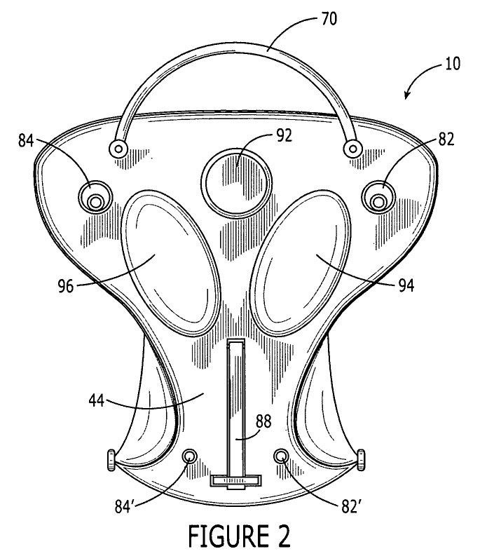

The Open Architecture Mobile Electronic Device 10 may include a support stand 88, as shown in FIG. 3. The support stand 88 helps support the Open Architecture Mobile Electronic Device 10 in an upright position when the user desires to operate the Device 10 in such fashion.

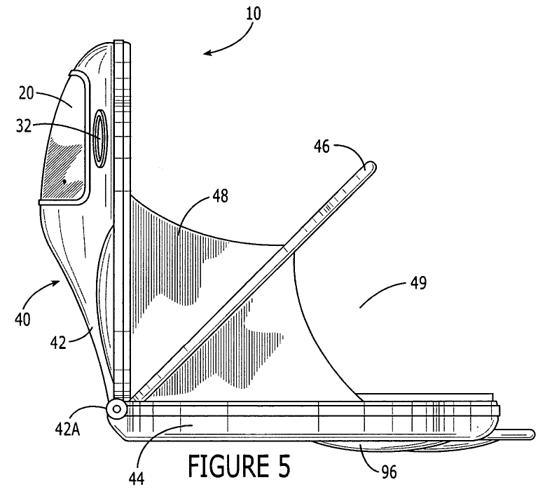

As shown in FIG. 5, the Open Architecture Mobile Electronic Device 10 can be opened to allow a user access to the interior of the body 40. The body 40 has a front portion 42, a rear portion 44, an internal support 46, webbing 48 and a storage space 49. The front 42 and back 44 may open and close along pivots 42A disposed on one side thereof. The front 42, back 44, internal support 46 and webbing 48 cooperatively the define storage space 49. The storage space 49 may be used to store CD's, DVD's or other items. The storage space 49 also may contain a battery [not shown] or other power device for the various circuits in the Open Architecture Mobile Electronic Device 10. Preferably, the battery (not shown) is rechargeable. In addition, the storage space 49 may hold a video game (not shown separately). The video game may be operated wirelessly or by plugging in the slot (60 in FIG. 1A), and displayed on the viewing screen 20 when operated.

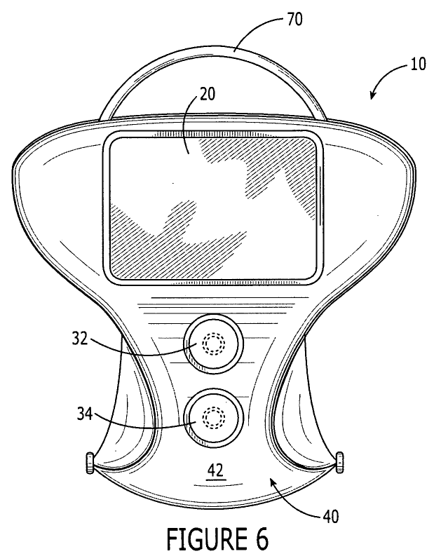

FIG. 6 illustrates an alternative embodiment of the Open Architecture Mobile Electronic Device 10 showing alternative positions for the view screen 20 and the speakers 32 and 34.

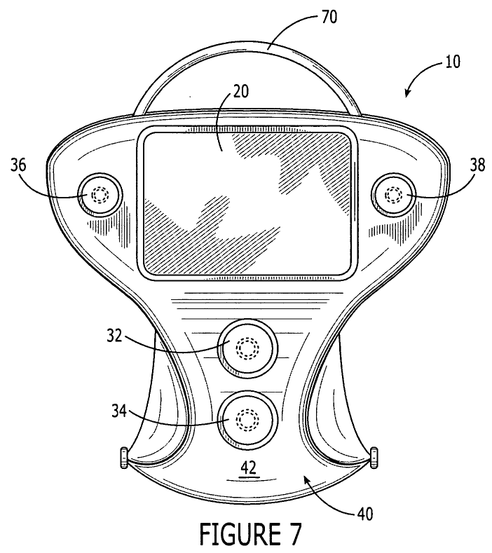

FIG. 7 illustrates an alternative embodiment of the Open Architecture Mobile Electronic Device 10 showing alternative positions for the view screen 20 and the speakers 32 and 34. The embodiment shown in FIG. 7 includes additional speakers 36 and 38.

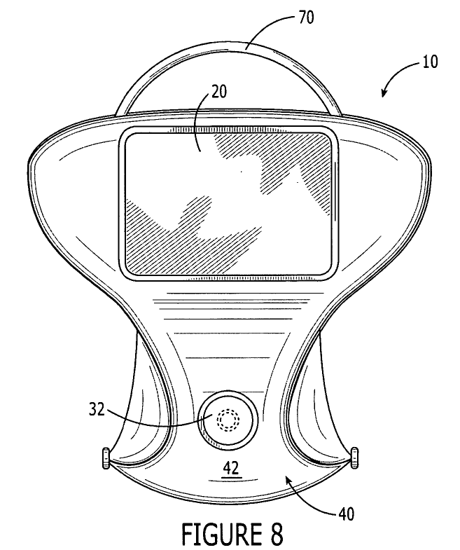

FIG. 8 illustrates another alternative embodiment of the Open Architecture Mobile Electronic Device 10 showing alternative positions for the view screen 20. The embodiment of FIG. 8 has only a single speaker 32.

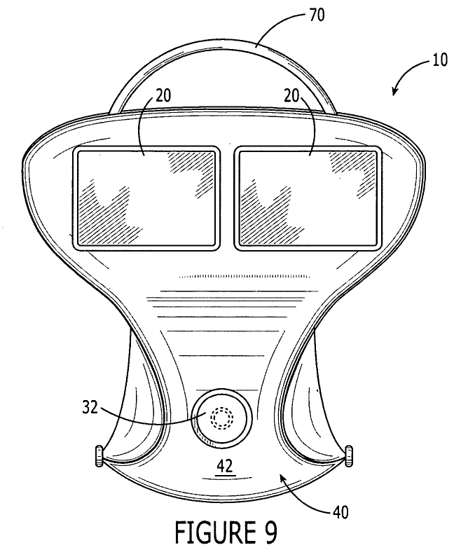

FIG. 9 illustrates an alternative embodiment of the Open Architecture Mobile Electronic Device 10 that includes two view screens 20 positioned side by side.

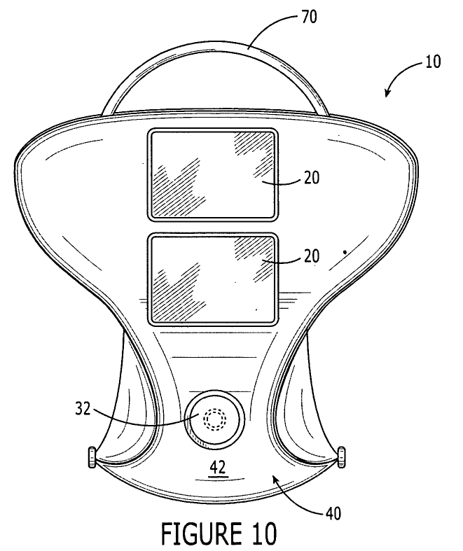

FIG. 10 illustrates an alternative embodiment of the Open Architecture Mobile Electronic Device 10 with dual view screens 20 positioned vertically.

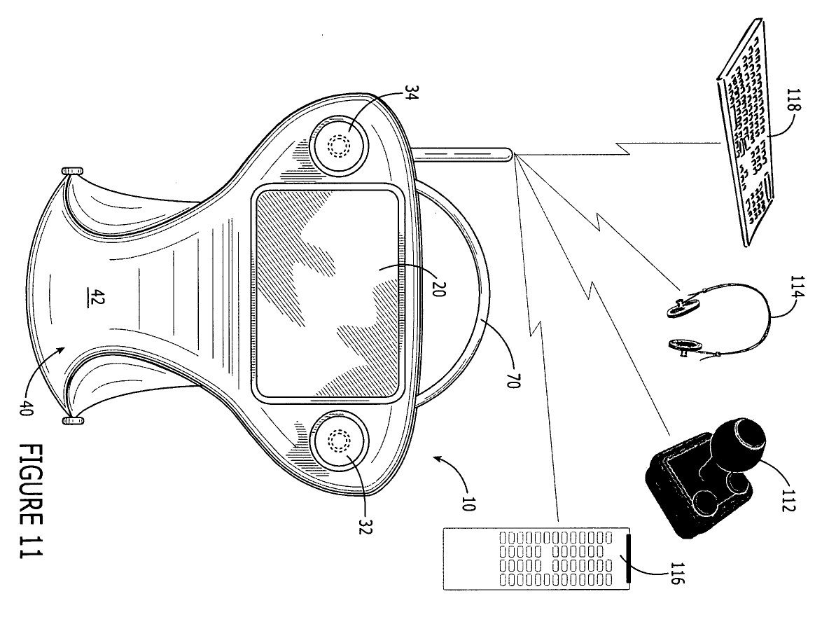

FIG. 11 illustrates an alternative embodiment of the Open Architecture Mobile Electronic Device 10 showing a number of peripheral devices that may be used with various implementations of the Device 10, including a game controller 112, headphones 114, a remote control 116 and a keyboard 118. The game controller 112, the headphones 114, the remote control 116 and the keyboard 118 could be cable or wirelessly connected to, and communicate with, the Open Architecture Mobile Electronic Device 10. An example of a game controller 112 would be a joystick. In addition, FIG. 11 illustrates the previously described antenna 99. In the present embodiment, the antenna 99 is positioned on the body 40 such that at least a portion of the antenna 99 extends outside the body 40, such that the antenna 99 can readily send and receive a signal from a remote source S or from any external device. The antenna 99 enables the Mobile Electronic Device 10 to communicate wirelessly, by receiving and sending signals through the transceiver (13 in FIG. 1A).

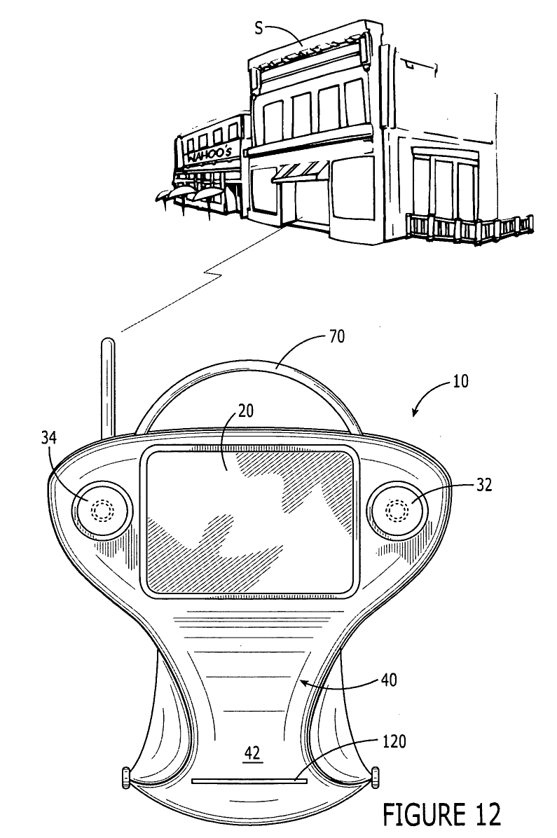

FIG. 12 illustrates the Open Architecture Mobile Electronic Device 10 receiving a signal from a remote signal source S. For example, the remote signal source S could be inside a store located near the user's position. The store's remote signal source S could send a signal to the Open Architecture Mobile Electronic Device 10 directing the controller (11 in FIG. 1A) to communicate print commands to the coupon printer 120 to print a promotional coupon for a particular product. Because the storage space (49 in FIG. 5) could contain a hard drive or similar accessible storage medium, the store computer (not shown separately) can collect information about whether the user has redeemed earlier promotional coupons by accessing a database (not shown separately) containing information about earlier coupon usage.

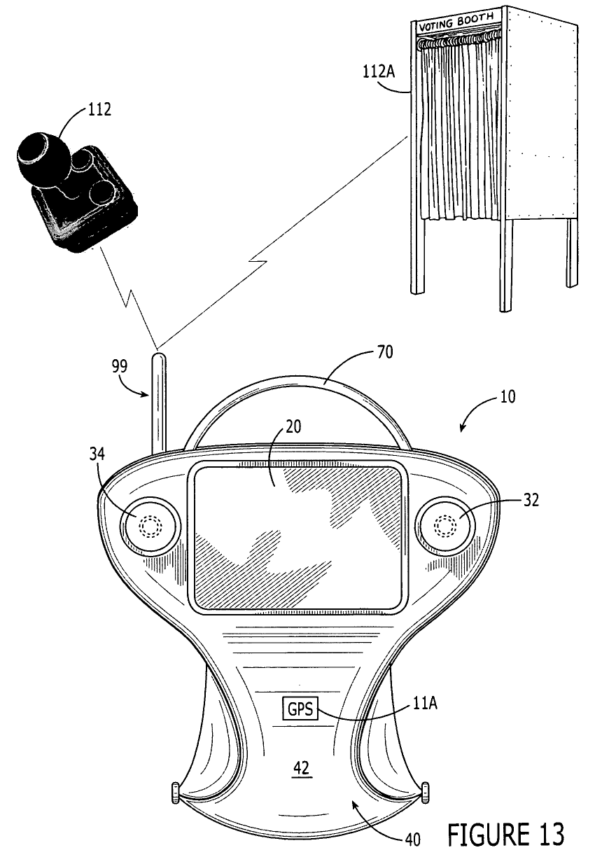

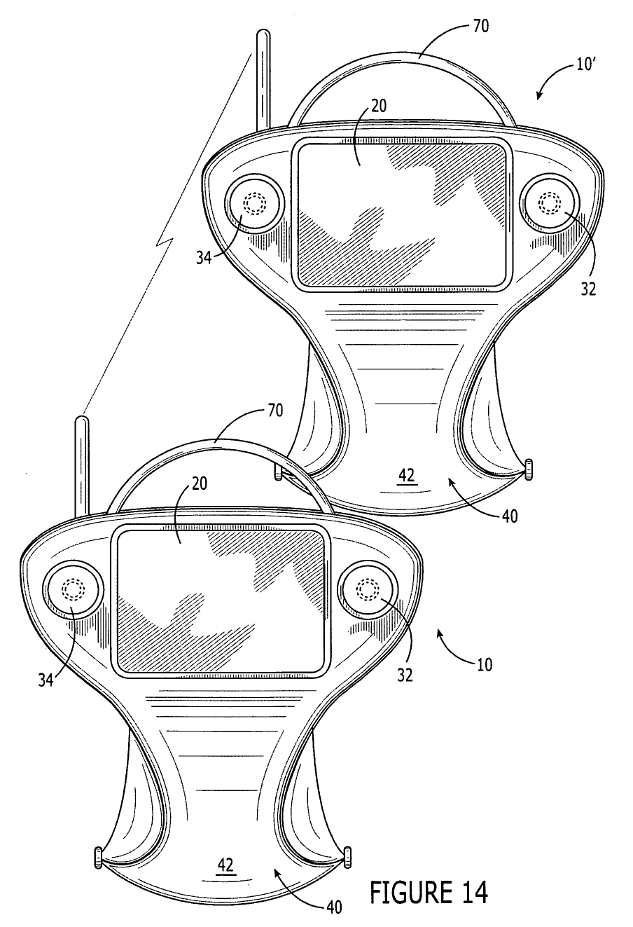

FIG. 13 illustrates other possible uses for the Open Architecture Mobile Electronic Device 10. For example, the user could indicate his preferences for particular items. A specific example is a dirigible orbiting over a sporting event. The dirigible can send a signal to all energized Open Architecture Mobile Electronic Devices 10 querying which soft drink or brand name each user preferred. Preference information could be stored on the hard drive in each Device 10 and can be used to cause generation of a promotional coupon.

It is within the scope of this invention for an Open Architecture Mobile Electronic Device 10 to allow the user to vote during an election. The ballot for the election may be transmitted from a polling place 112A and would be displayed on the view screen 20. The user would then cast his or her ballot by selecting the candidates name using the keyboard (118 in FIG. 11), the hand controller (112 in FIG. 11) or activating suitable portions of the view screen 20 when the view screen is a touch sensitive screen.

It is also within the scope of the present invention for the Open Architecture Mobile Electronic Device 10 to communicate with another, similar Open Architecture Mobile Electronic Device 10 when certain preselected criteria are matched. For example, a first user would enter certain criteria into his Open Architecture Mobile Electronic Device 10 indicating that the first user would like to contact any other Open Architecture Mobile Electronic Device 10 user that shares a common interest, for example, fly fishing or visiting museums to view impressionist art. When the first user came within communication distance of a second user having such Open Architecture Mobile Electronic Device 10′, the two Open Architecture Mobile Electronic Devices 10, 10′ would communicate the shared interest and each would print out a picture of the other user or similar personal data. If the two users then chose to meet personally, they could readily locate one another using the photographs or other personal data. Alternatively, each Open Architecture Mobile Electronic Device 10, 10′ could include a global positioning satellite system (“GPS”) receiver 11A to determine geodetic position of the Device 10 and communicate such position to the other Open Architecture Mobile Electronic Device 10′. Alternatively, the Open Architecture Mobile Electronic Device 10 could print out a telephone number, wireless or other, of the user of Open Architecture Mobile Electronic Device 10′ and the first user could telephone the second user to establish contact.

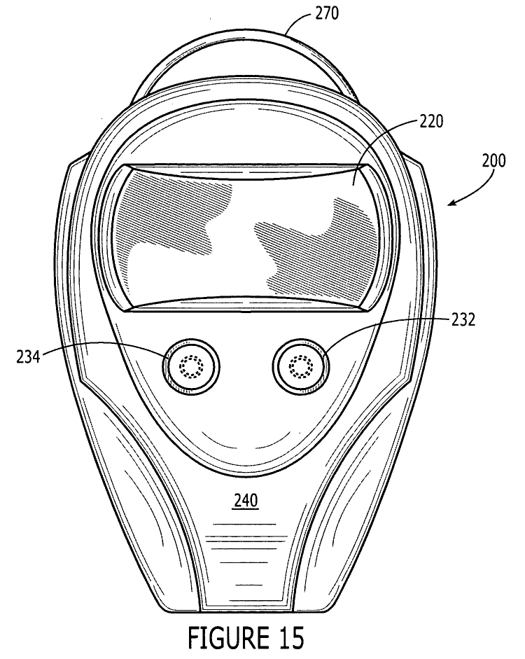

FIG. 15 illustrates another embodiment of the Open Architecture Mobile Electronic Device 200. The Open Architecture Mobile Electronic Device 200 in FIG. 15 includes a view screen 220, speakers 232 and 234 and a body 240. The view screen 220 may be a flat-panel liquid crystal display television receiver, or any type of viewable screen, substantially as explained above with reference to FIGS. 1 and 1A. In addition, the view screen 220 may be detachable from the Open Architecture Mobile Electronic Device 200. The view screen 220 may be detachable for purposes of, among others, replacing it with another viewing screen, or the view screen 220 may be detached to serve as a wirelessly connected display to allow the user to watch television, DVD's or similar media. The speakers 232 and 234 are used to play the audio portion of any media played by the Open Architecture Mobile Electronic Device 200. Typically, the Open Architecture Mobile Electronic Device 200 will also include a slot 260. The speakers 232 and 234 may be detachable from the body 40 for purposes of replacing them with other speakers, or the speakers 232, 234 may be detached from the body 40 to serve as wired- or wirelessly connected speakers to enable the user to obtain better sound quality.

The view screen 220 may be a conventional broadcast television receiver or may be a touch-sensitive interface screen. In addition, the view screen 220 may be a video display for a video game or computer monitor.

The body 240 is preferably made from an impact resistant material such as a hard plastic, glass fiber reinforced plastic or any similar material that will resist damage from any impact that may occur when a user is carrying or transporting the Open Architecture Mobile Electronic Device 200.

The embodiment shown in FIGS. 15 and 15A may include controller and bus hardware substantially as shown in and explained with reference to FIG. 1A.

As shown in FIGS. 15 and 15A, slot 260 allows the user exchange a media reader, such as DVD player 350, with another media reader, such as a CD player 360. In addition, slot 260 could also hold a coupon printer 320 or a printer 322. It is within the scope of the present invention for the Open Architecture Mobile Electronic Device 260 to include a plurality of such slots. If the Open Architecture Mobile Electronic Device 200 includes more than one such slot, the user could use a plurality of media reader/mass storage devices (320, 322, 350 or 360) simultaneously.

As shown in FIG. 15, the Open Architecture Mobile Electronic Device 200 includes hand strap 270. The strap 270 allows the user to comfortably lift and transport the Open Architecture Mobile Electronic Device 200. Preferably, the strap 270 is sufficiently strong and is fastened to the Open Architecture Mobile Electronic Device 200 so that it will not detach from the body 240, and resists breakage if the user accidentally drops the Open Architecture Mobile Electronic Device 200.

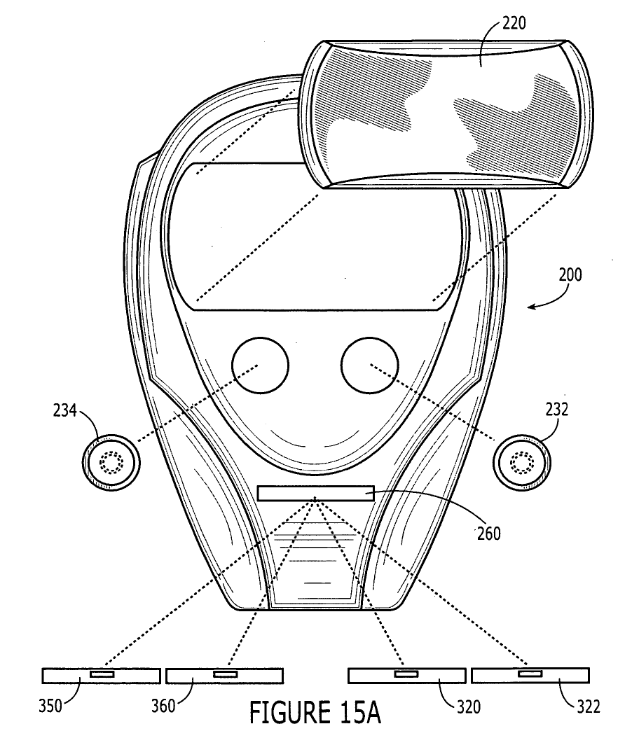

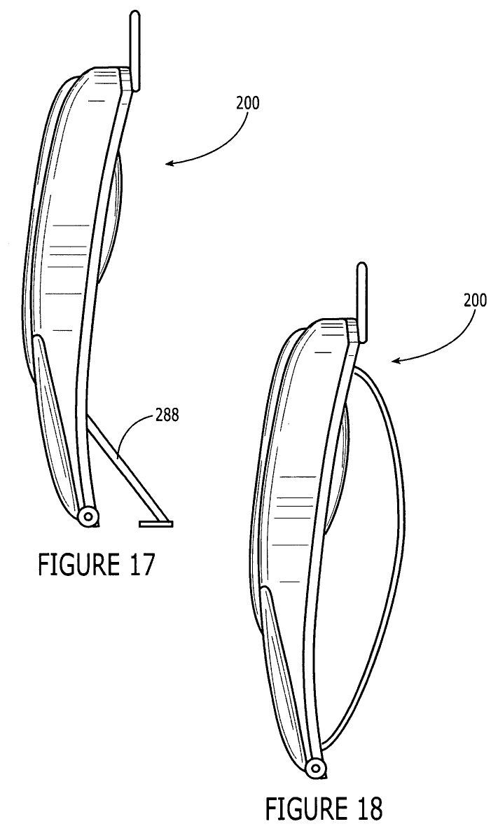

FIG. 16 shows the reverse side of the Open Architecture Mobile Electronic Device 200. Strap holders 282′ and 284′ connect to strap connection points, 282 and 284 respectively, using straps (286 in FIG. 18). Cushions 292, 294 and 296[not shown] may be positioned on the body 240 to maximize the user's comfort when transporting the Open Architecture Mobile Electronic Device 200 using the shoulder straps (286 in FIG. 18).

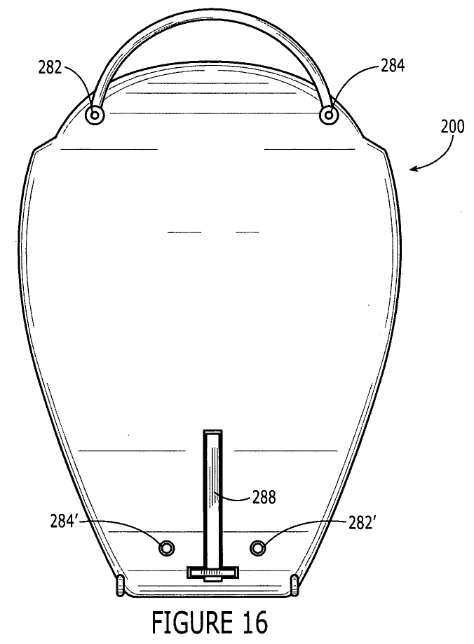

The Open Architecture Mobile Electronic Device 200 may include a support stand, 288, as shown in FIG. 17. The support stand 288 helps support the Open Architecture Mobile Electronic Device 200 in an upright position when the user so desires to operate the Device 200 in such position.

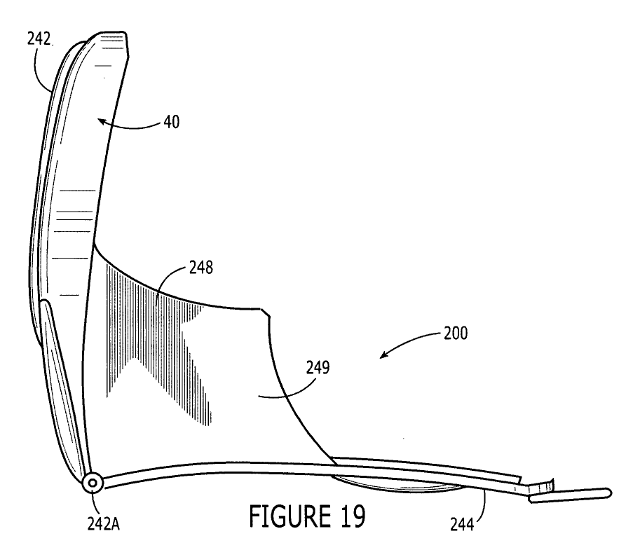

As shown in FIG. 19, the Open Architecture Mobile Electronic Device 200 can be opened to allow a user access to the interior of the body 240. The body 240 has a front portion 242, a rear portion 244; webbing 248 and a storage space 249. The front 242 and back 244 can be opened by being jointly moving corresponding ends by a pivot 242A. The front 242, back 244 and webbing 248 cooperatively define the storage space 249. The storage space 249 may be used to store CD's, DVD's or other items. The storage space 249 also may contain a battery [not shown] or other power device for the Open Architecture Mobile Electronic Device 200. Preferably, the battery (not shown) is rechargeable. In addition, the storage space 249 may hold a video game (not shown). The video game (not shown) may be displayed on the viewing screen (220 in FIG. 15A). In the present embodiment, the front portion 242 and the rear portion 244 are held in the closed position, as shown in FIG. 18, by a zipper. It is within the scope of the present invention that other equivalent fasteners, such as clips, fastening cloth such as sold under the trademark VELCRO or the like could be used to hold front portion 242 and rear portion 244 in close alignment. It is also within the scope of the present invention that the front portion 242 and the rear portion 244 can be opened and closed at will by the user. In other words, the front portion 242 and the rear portion 244 can be opened to reveal storage space 249 and then closed to conceal the storage space 249.

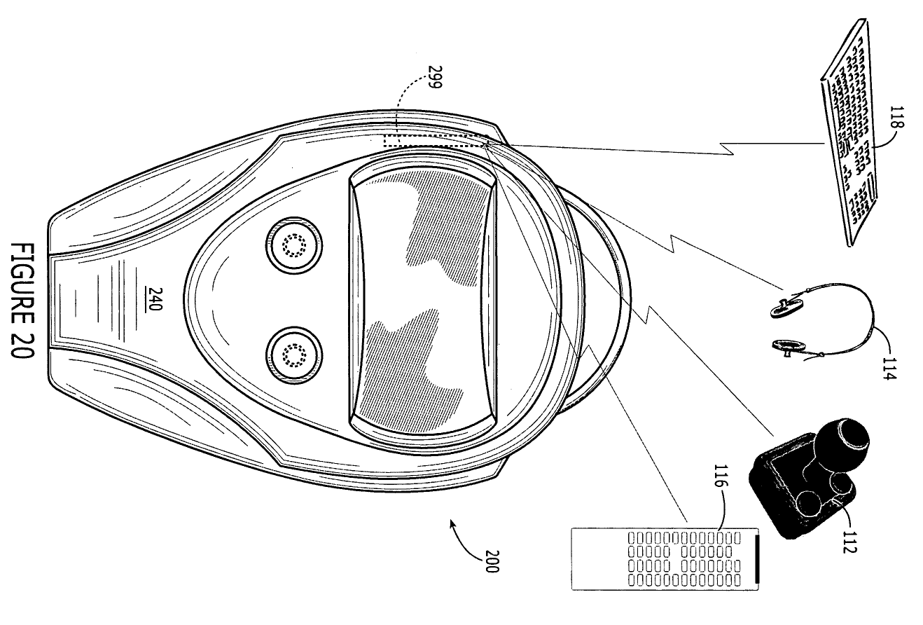

FIG. 20 illustrates an alternative embodiment of the Open Architecture Mobile Electronic Device 200 showing possible peripheral devices such as a game controller 112, headphones 114, a remote control 116 and a keyboard 118. The game controller 112, the headphones 114, the remote control 116 and the keyboard 118 could be connected to, and communicate with, the Open Architecture Mobile Electronic Device 200 wirelessly, as explained above with reference to FIG. 11, or such peripheral devices could be hard wired to the Device 10. An example of the game controller 112 would be a joystick. FIG. 20 also illustrates an antenna 299. In the preset embodiment, the antenna 299 is positioned on the body 240 such that at least a portion of the antenna 299 extends outside the body 240, such that antenna 299 can readily send and receive signals to and from a remote source S, or any peripheral device.

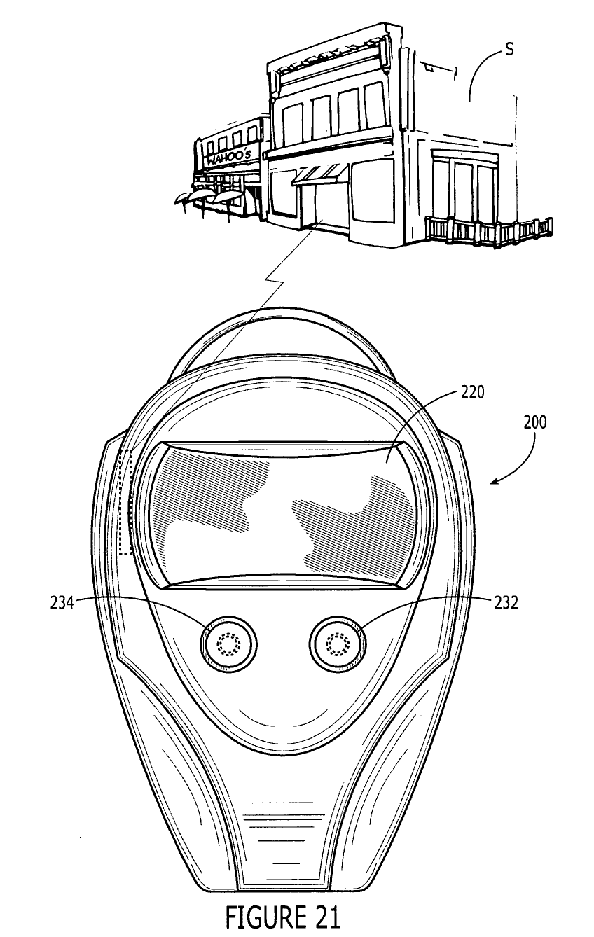

FIG. 21 illustrates the Open Architecture Mobile Electronic Device 200 receiving a signal from a remote signal source S. For example, the remote signal source S could be inside a store located near the user's position. The store's remote signal source S would send a signal to the Open Architecture Mobile Electronic Device 200 directing a coupon printer 320 (when such is in the slot) to print a promotional coupon for a particular product. Because the storage space 249 could contain a hard drive, or similar accessible storage medium, a computer (not shown) in the can collect information about whether the user has redeemed earlier coupons by accessing a database concerning information earlier coupon usage when such is stored on a hard drive in the Device 200. It is within the scope of the present invention that the storage space 249 could contain a computer (not shown) with all the associated processing power associated with such a device. For example, the view screen 220 could be directly, or indirectly connected to such a computer, and the user could interact with the computer using the key board (118 in FIG. 20), the game controller (112 in FIG. 20) or the screen 220 itself if the screen 220 is a “touch screen” device.

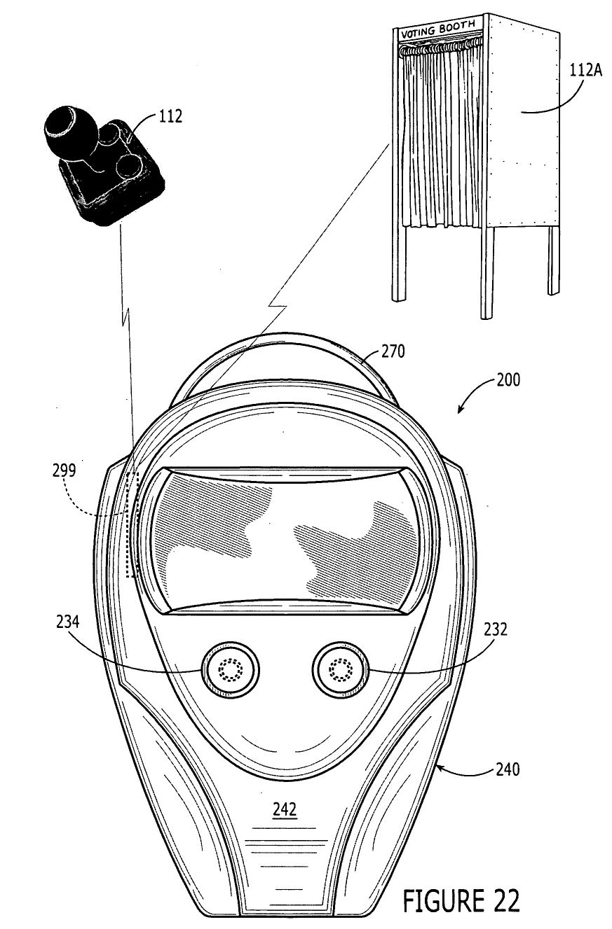

FIG. 22 illustrates other potential uses for the Open Architecture Mobile Electronic Device 200. For example, the user could indicate his personal preferences by voting. A specific example is a dirigible orbiting over a sporting event. The dirigible would send a signal to all energized Open Architecture Mobile Electronic Devices 200 with a query as to which soft drink or brand name each user preferred. Such preference information can be stored on the hard drive or computer and can be used to generate a promotional coupon.

It is within the scope of the present invention for the Open Architecture Mobile Electronic Device 200 to enable the user to vote during an election. The ballot can be transmitted from a polling place 112A and is displayed on view screen 220. The user would then cast the ballot by selecting the candidates using, for example, the keyboard (118, in FIG. 20) the game controller (112 in FIG. 20) or the view screen 220 if the screen is a touch sensitive interface device.

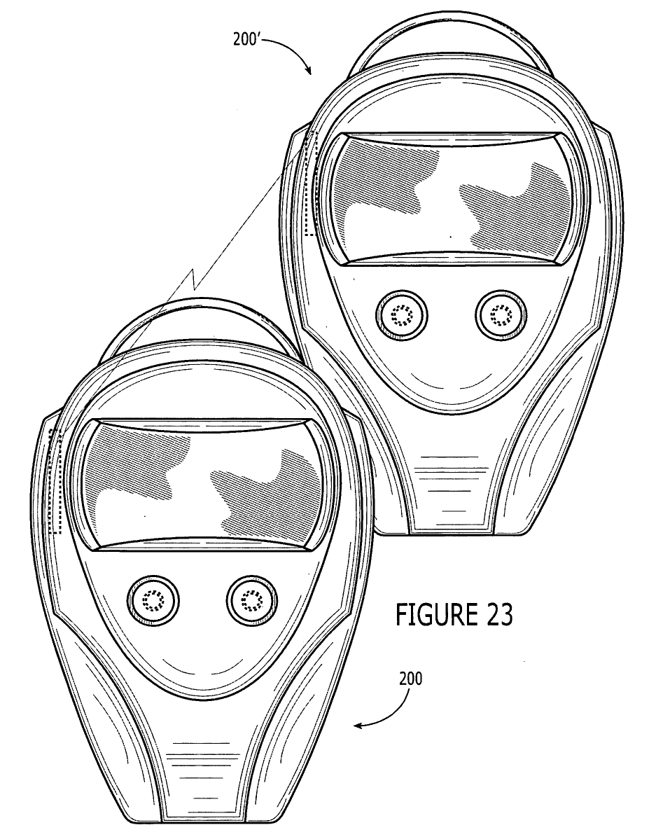

Referring to FIG. 23, it is also within the scope of the present invention for an Open Architecture Mobile Electronic Device 200 to communicate with another, similar Open Architecture Mobile Electronic Device 200′ when certain preselected criteria are matched. For example, a first user would enter certain criteria into Open Architecture Mobile Electronic Device 200 indicating that he would like to contact any other Open Architecture Mobile Electronic Device user that shares a common interest, such as fly fishing or visiting museums to view impressionist art. When the first user came within communication distance of a second user using a similar Open Architecture Mobile Electronic Device 200′, the two Open Architecture Mobile Electronic Devices would communicate the shared interest and, for example, each Device 200, 200′ would print out a picture of the other user (if a printer is disposed in the slot). If the two users then chose to meet personally, they could readily locate one another using the photographs. Alternatively, each Open Architecture Mobile Electronic Device could have a GPS receiver and communicate the geodetic position thereof to the other Open Architecture Mobile Electronic Device. Alternatively, the Open Architecture Mobile Electronic Device 200 could print out the telephone number of the user of the other Open Architecture Mobile Electronic Device 200′, and the first user could telephone the second user.

Embodiments of a Mobile Electronic Device according to the invention can provide users with a readily reconfigurable, multiple use, broadband wireless device that enables transport of a plurality of different electronic entertainment and personal business devices, and enables exchange of information between such devices and/or between such devices and other wireless devices.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A portable electronic device, comprising:
a body having pivotally joined front and back sections such that an interior space is defined therebetween;
at least one receptacle in the body for releasable connection of a viewing device therein;
at least one receptacle in the body for releasable connection of a storage device therein;
means for communicating electrical signals between the at least one viewing device and the at least one storage device and,
means for communicating between the at least one viewing devices and at least one peripheral device.

2. The portable electronic device of claim 1, further comprising at least one audio speaker releasably connected to the body, the speaker operatively coupled to the portable electronic device such that an audio portion of a signal communicated from at least one of the viewing device and the storage device is played through the at least one speaker.

3. The portable electronic device of claim 2 wherein the at least one audio speaker is wirelessly coupled to the portable electronic device.

4. The portable electronic device of claim 1 wherein the storage device comprises at least one of a printer, a computer hard drive, a compact disk reader and a digital video disk reader.

5. The portable electronic device of claim 1 wherein the at least one peripheral device comprises at least one of a game controller, a keyboard and a remote control.

6. The portable electronic device of claim 1 further comprising a broadband data transceiver.

7. The portable electronic device of claim 1 wherein the viewing device comprises one of a flat screen liquid crystal display, a television receiver, a cathode ray tube and a touch screen interface device.

8. The portable electronic device of claim 1 further comprising a bus controller, and wherein the at least one peripheral device communicates with the bus controller using a wireless link, the bus controller operatively connected to the at least one viewing device, the bus controller operatively connected to the at least one storage device.

9. The portable electronic device of claim 1 further comprising shoulder straps affixed to the body.

10. The portable electronic device of claim 9 further comprising at least one cushion affixed to the body such that the cushion is interposed between the body and the body of a user when the user carries the body by the shoulder straps.

11. The portable electronic device of claim 1 further comprising a handle affixed to an upper portion of the body.
